(19) United States
(12) Patent Application Publication
(10) Pub. No.: US 2018/0003313 A1
(43) Pub. Date: Jan. 4, 2018

(54) SOLENOID VALVE FOR THE AUTOMOTIVE INDUSTRY

(71) Applicant: PIERBURG GMBH, NEUSS (DE)

(72) Inventors: FRANZ-JOSEF SCHNELKER, NEUSS (DE); ALVITO FERNANDES, LEVERKUSEN (DE); JANUSZ ZURKE, STRAELEN (DE)

(73) Assignee: PIERBURG GMBH, NEUSS (DE)

(21) Appl. No.: 15/547,520

(22) PCT Filed: Jan. 13, 2016
(86) PCT No.: PCT/EP2016/050556

§ 371 Date: Jul. 31, 2017

(30) Foreign Application Priority Data
Feb. 2, 2015 (DE) 10 2015 101 477.7

(51) Int. Cl. F16K 31/06; F01P 7/14; F16K 1/36; H01F 7/128

(52) U.S. Cl. CPC F16K 31/0693; H01F 7/128; F01P 7/14; F16K 1/36; F01P 2007/146

(57) ABSTRACT

A solenoid valve for the automotive industry includes a housing comprising an inlet channel and an outlet channel. An electromagnetic circuit is arranged in the housing. The electromagnetic circuit includes a coil wound onto a coil carrier, an armature, a core, and a return device. The armature and the core are arranged in a valve interior. A valve rod is arranged to adjoin the armature. The valve rod is movably mounted in the core via a bearing. A sleeve body seals the valve interior. The sleeve body is provided as a bearing element for the armature. A valve closure body is operatively connected to the armature. The valve closure body includes pressure equalization openings and is movably mounted in the sleeve body via a first sealing element. A spring pre-tensions the armature.

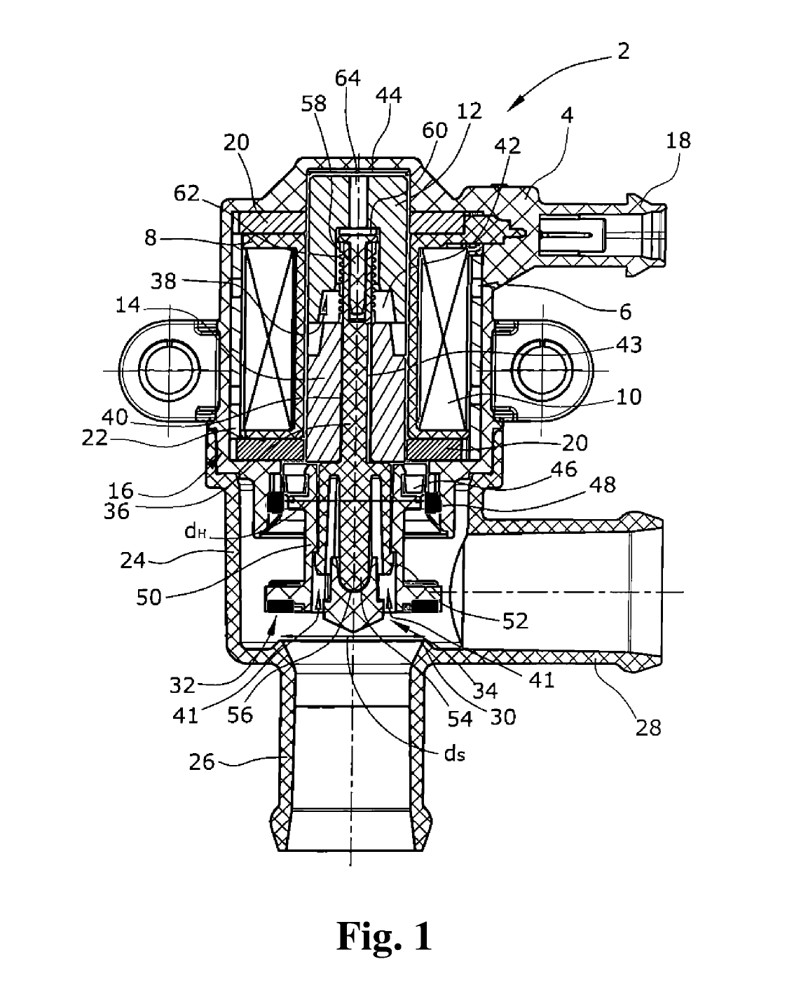

The invention relates to a solenoid valve for the automotive industry, comprising a housing which has an inlet conduit and an outlet conduit, wherein, in the housing, an electromagnetic circuit is provided, which is made up of a coil wound onto a coil carrier, an armature, a core, and a return device, wherein the armature and the core are arranged in a valve interior and wherein a valve rod, which is movably mounted in the core by means of bearing means, adjoins the armature, wherein the armature is operatively connected to a valve closure body, wherein spring means are provided for pre-tensioning the armature, and wherein a sleeve body is provided for sealing the valve interior, wherein the sleeve body is designed as a bearing element for the armature.

Such solenoid valves are well known from prior art. They are used e.g. as divert-air valves, coolant switch valves, oil valves or also as oil modulators. For an effective sealing of the electromagnetic circuit against the fluid to be controlled or regulated, it is known to seal the valve interior from the coil carrier by means of a sleeve body. An example for such a solenoid valve is found in DE 196 03 384 A1. Here, the sleeve body is designed as a guide sleeve mounting the armature for movement in the axial direction. The valve closure body is formed as a spherical valve closure element which cooperates with a valve seat in a manner known per se. A pressure equalization with an inlet channel to be switched is desired in particular for switch valves, in order to realize short switching times with little effort. This is not possible with the generic solenoid valve.

Therefore, it is an object of the present invention to provide a solenoid valve of the generic type in a simple and economic manner, which valve guarantees a safe pressure equalization in a simple and economic manner.

This object is achieved by the closure body having pressure equalization openings and being movably mounted in the sleeve body by means of a sealing element. Such a structural design guarantees a simple and economic sealing of the valve interior from the environment, whereby a simple pressure equalization becomes possible.

In an advantageous embodiment the sleeve body is locked in the housing under pre-tension, whereby the sleeve body is fixed axially in a simple manner. A second sealing element may be arranged between the sleeve body and the housing, whereby a safe sealing of the coil is guaranteed. The valve rod may in an advantageous manner be movably mounted in the core by means of a slide bore. As an alternative, e.g. a slide bushing may be provided.

The pressure equalization openings are connected in an advantageous manner to the valve interior by means of tolerances of the gimbal mounting means and by means of longitudinal grooves or recesses in the valve rod. In the case of an armature arranged above the core and averted from the valve closure body, a bore may be provided in the armature.

In order to guarantee an optimal pressure equalization in a simple manner, it is advantageous if the diameter d_{S} of the valve seat is equal to the diameter d_{H} of the valve sleeve in the region of the sealing element.

The invention is described in detail hereunder with reference to the drawings, the sole FIGURE showing a first sectional view of the solenoid valve according to the present invention.

The sole FIGURE shows a sectional view of a solenoid valve 2 according to the present invention. This solenoid valve 2 has a housing 4 in which an electromagnetic circuit 6 is provided which is substantially formed by a coil 10 wound on a coil carrier 8, an armature 12, a core 14 and a return means 16. By means of an electrical plug 18, the coil 10 may be connected in a manner known per se to an engine control not illustrated in detail. As is known, the return means 16 is formed by a return plate arrangement 20 and a yoke 22.

In the present embodiment the solenoid valve 2 is configured as a coolant switch valve and, for this purpose, has a connection body 24 with a coolant inlet channel 26 and a coolant outlet channel 28. In a manner known per se, the coolant inlet channel 26 comprises a valve seat which cooperates with a valve closure body 32 in a manner known per se. This valve closure body 32 is connected to a valve rod 36 by means of gimbal mounting means 34. The valve rod 36 itself is operatively connected to the armature 12 by means of unilateral form fitting means 38 acting in the axial direction and is movably mounted in the core 14 by means of a slide bore 40. In the present embodiment the valve closure body 32 has two pressure equalization openings 41 fluidically connecting a valve interior 42 to the coolant inlet channel 26, so that the solenoid valve 2 can operate in an entirely pressure-equalized state. For this purpose, the coolant may enter into the valve closure body 32 through the pressure equalization openings 41 and may reach the valve interior 42 through tolerances of the gimbal mounting means 43 as well as by means of longitudinal grooves 43 of the valve rod 36. For sealing the coil body against the valve interior 42 and the fluid therein, as well as against possible contaminations, a sleeve body 44 is provided which is locked with the housing 4. The valve closure body 32 is movably mounted in the sleeve body 44 by means of a first sealing element 46, which sleeve body is further sealed against the housing 4 by a second sealing element 48. The diameter d_{S} of the valve seat 30 is equal to the diameter d_{H} of the valve sleeve 44 in the region of the sealing element 46 and thus guarantees for an optimal pressure equalization.

In the present embodiment the gimbal mounting means 34 are formed by locking elements 50 arranged on the valve closure body 32, which elements cooperate with spring elements 52 arranged on the valve rod 36, such that the valve rod 36 is resiliently connected to the valve closure body 32 with play. Further, the valve rod 36 is spherically shaped at the end 54 directed to the valve closure body 32 and engages in a corresponding spherical recess 56 of the valve closure body 32. Further, the form fitting means 38 are formed by a pin element 58 and a blind hole 60 in the armature, wherein the pin element 58 is locked in the valve rod 38 and engages in the blind hole 60 with play. A spring element 62 is provided between the pin 58 and the core 14, whereby the valve rod 36, and thus also the armature 12, is pre-tensioned in an open position in the non-energized state. Since, in the present embodiment, the armature 12 is arranged above the core 14, facing away from the valve closure body 32, the armature 12 has a bore 64 which allows the pin element 58 to be locked during assembly by using a tool. As an alternative it is also possible to provide the core 14, the valve rod 36, as well as the pin element 58 and the spring element 62 as a pre-assembled unit. Further, this bore 64 guarantees a flow of coolant into the valve interior 42 above the armature 12.

With the solenoid valve 2 of the present invention a simple structure is guaranteed, wherein the valve interior 42 of the solenoid valve 2 is optimally sealed against the coil 10 and, still, pressure equalization, and thus an appropriate design of the electromagnetic circuit 6, is possible.

1-7. (canceled)

8. A solenoid valve for the automotive industry, the solenoid valve comprising:
a housing comprising an inlet channel and an outlet channel;
an electromagnetic circuit arranged in the housing, the electromagnetic circuit comprising a coil wound onto a coil carrier, an armature, a core, and a return device, the armature and the core being arranged in a valve interior;
a valve rod arranged to adjoin the armature, the valve rod being movably mounted in the core via a bearing;
a sleeve body configured to seal the valve interior, the sleeve body being provided as a bearing element for the armature;
a valve closure body operatively connected to the armature, the valve closure body comprising pressure equalization openings and being movably mounted in the sleeve body via a first sealing element; and
a spring configured to pre-tension the armature.

9. The solenoid valve as recited in claim 8, wherein the sleeve body is further configured to be locked in the housing under a pre-tension.

10. The solenoid valve as recited in claim 8, further comprising:
a second sealing element arranged between the sleeve body and the housing.

11. The solenoid valve as recited in claim 8, further comprising:
a slide bore,
wherein,
the valve rod is movably mounted in the core via the slide bore.

12. The solenoid valve as recited in claim 8, further comprising:
a gimbal mounting; and
longitudinal grooves or recesses,
wherein,
the pressure equalization openings are connected to the valve interior through tolerances of the gimbal mounting and the longitudinal grooves or recesses in the valve rod.

13. The solenoid valve as recited in claim 8, wherein the armature comprises a bore.

14. The solenoid valve as recited in claim 8, further comprising:
a valve seat comprising a diameter,
wherein,
the sleeve body comprises a diameter, and
the diameter of the valve seat is equal to the diameter of the sleeve body in a region of the first sealing element.
